(19) United States
(12) Patent Application Publication
(10) Pub. No.: US 2005/0243283 A1
(43) Pub. Date: Nov. 3, 2005

(54) Reflective type beam splitting and combining device

(76) Inventors: Ching-Fuh Lin, Taipei City (TW); Shu-I Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/833,140

(22) Filed: Apr. 28, 2004

(51) Int. Cl. G03B 21/00

(52) U.S. Cl. 353/33

(57) ABSTRACT

A reflective type beam splitting and combining device comprises a cubic prism set and three light valves. A first dielectric thin film and a second dielectric thin film are formed on diagonal tangential planes of two sets of opposed surfaces of the prism set so that the prism set can reflect or transmit two light beams of the three primary colors incident from two incidence faces, respectively. The three light valves are arranged on three adjacent surfaces of the prism set to let every two of them be adjacent to each other. The three light valves are used for modulating the three primary colors transmitted or reflected by the prism set. Finally, the three primary color lights are assembled into an output light beam by the prism set. The above optical structure can effectively shorten the back focus to shrink the size and reduce the difficulty in manufacturing.

### FIELD OF THE INVENTION

The present invention relates to a reflective type beam splitting and combining device and, more particularly, to a reflective type beam splitting and combining device used in a reflective type optical projection display system for full-color projection.

### BACKGROUND OF THE INVENTION

There are two main developments in the technology of optical projection display systems. One tends to miniaturize the size and weight; the other tends to enhance the luminous efficiency, including the brightness and resolution.

Although reflective type liquid crystal projection display systems have different system architectures, almost all of them adopt an X-prism. The whole system is composed of an X-prism and three polarizing beam splitters (PBS) to form an imaging system. The imaging system makes use of dichroic mirrors to split an incident light into three primary color lights (R, G and B), which enter three different PBS and are reflected and transmitted by the glued planes of the PBS to three reflective type liquid crystal plates (R, G and B). The three exit light beams (R, G, and B) pass through the glued planes of the PBS, are combined at the X-prism, and are projected out by a projection lens onto a screen. These reflective type liquid crystal projection display systems have the same design idea (e.g., the three light beams R, G and B), and only differ in the energy usage efficiencies and sizes of their light projection systems.

For example, a reflective type liquid crystal projection display system making use of an X-prism has a longer back focus, causing a larger size, more difficulty in manufacturing and a higher cost. Therefore, the present invention aims to propose a reflective type beam splitting and combining device used in an optical projection display system for solving the above drawbacks in the prior art.

### SUMMARY AND OBJECTS OF THE INVENTION

The primary object of the present invention is to provide a reflective type beam splitting and combining device, which makes use of a specially designed prism set matched with three different light valves to combine polarized light beams of the three primary colors (R, G and B) into a single light beam, thereby accomplishing the shortest back focus and the highest usage efficiency.

Another object of the present invention is to provide a reflective type beam splitting and combining device having the advantages of a small size, simple manufacturing, and a lower cost to effectively solve the problem of difficulty in manufacturing in the prior art.

To achieve the above objects, a reflective type beam splitting and combining device of the present invention comprises a cubic prism set and three light valves. A first dielectric thin film is formed on the diagonal tangential plane of upper and lower opposed surfaces of the prism set. A second dielectric thin film is formed on the diagonal tangential plane of left and right opposed surfaces of the prism set. Through the first and second dielectric thin films, the prism set can respectively reflect and transmit two light beams of the three primary colors incident from two incidence faces. The three light valves are arranged on three adjacent surfaces of the prism set to let every two of the three light valves be adjacent to each other. The three light valves are used for modulating the three primary color lights transmitted or reflected by the prism set to convert them into inversely polarized lights. The three primary color lights are then assembled into an output light beam by the prism set. Finally, the output light beam is projected out.

The above cubic optical structure has six surfaces. The three light valves are disposed on three surfaces adjacent to one another. Two of the remaining three surfaces are used as the incidence planes, and the last one is used as an exit plane of the output light beam. In other words, all the six surfaces of the above cubic optical structure are made use of to let the size of the beam splitting and combining device be very small and the number of required optical components be very little, hence greatly simplifying the assembly process of a reflective type optical image projection device or an optical engine and lowering the complexity and difficulty in assembly.

The various objects and advantages of the present invention will be more readily understood from the following detailed description when read in conjunction with the appended drawings, in which:

### BRIEF DESCRIPTION OF DRAWING

FIG. 1 is a three-dimensional structure diagram of the present invention;

FIG. 2 is an exploded perspective structure diagram of the present invention;

FIGS. 3(a) and 3(b) are structure diagrams of a prism set used in the present invention;

FIG. 4 is a diagram showing how the present invention is used in an optical projection display system;

FIG. 5 is a diagram showing optical paths of the three primary color lights according to an embodiment of the present invention; and

FIG. 6 is a diagram showing optical paths of the three primary color lights according to another embodiment of the present invention.

### DETAILED DESCRIPTION OF PREFERRED EMBODIMENT

The present invention proposes a reflective type beam splitting and combining device, which makes use of a specially designed prism set matched with three different reflective type liquid crystal plates to modulate thee primary color lights (R, G and B) and combine polarized light beams of them into a single light beam for accomplishing the shortest back focus and the highest usage efficiency. The reflective type beam splitting and combining device can extensively apply to optical image projection devices such as optical engines, projectors, back projection televisions, digital movie projection devices and digital image simulators.

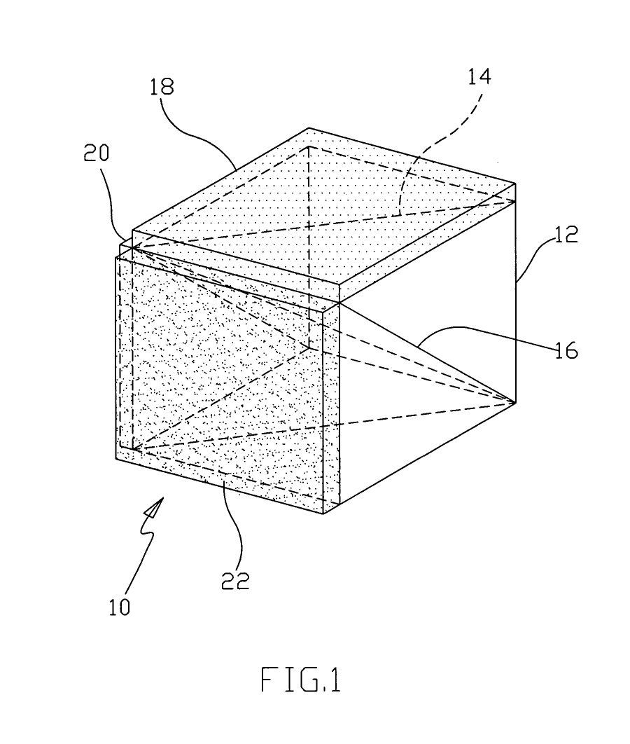

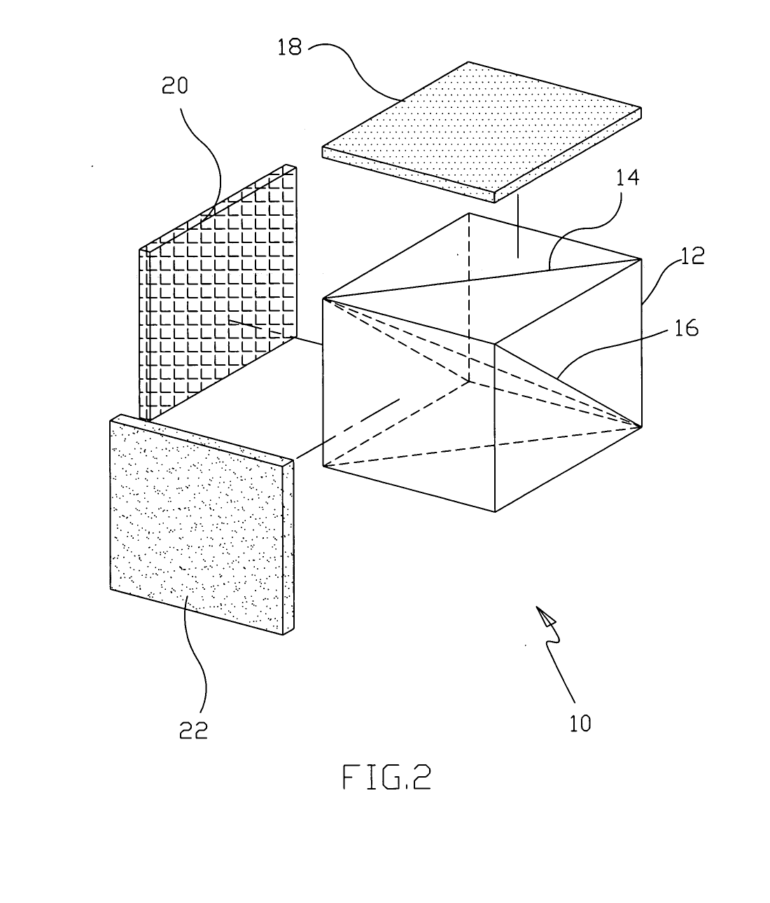

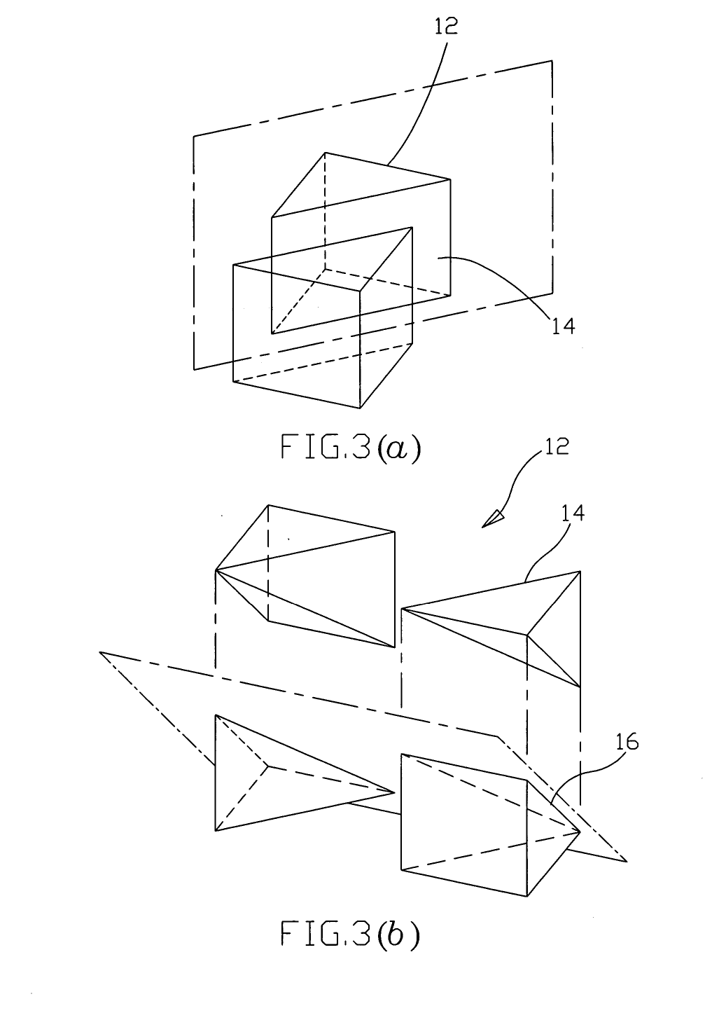

As shown in FIGS. 1 and 2, a reflective type beam splitting and combining device 10 is composed of a prism set 12 and three light valves 18, 20 and 22. The prism set 12 is a cubic structure, and is made of glass or other materials transparent to the three primary colors. A first dielectric thin film 14 is formed on the diagonal tangential plane of upper and lower opposed surfaces of the cubic structure. A second dielectric thin film 16 is formed on the diagonal tangential plane of left and right opposed surfaces of the cubic structure. The positions of the first and second dielectric thin films 14 and 16 on the diagonal tangential planes of the cubic prism set 12 can refer to FIGS. 3(a) and 3 (b). The first and second dielectric thin films 14 and 16 are made with different coating conditions, and can partition the prism set into four prisms to let the prism set have six outer surfaces. The four prisms can be assembled together to form the cubic prism set 12 by means of gluing or a mechanical structure. Besides, the gap of the joint faces of the four prisms is smaller than about 15 micrometers. The prism set 12 can respectively reflect and transmit two light beams of the three primary colors incident from two incidence planes (i.e., the right and lower surfaces).

Please refer to FIGS. 1 and 2. The three light valves include a blue light valve 18, a red light valve 20 and a green light valve 22. They are disposed on three surfaces adjacent to one another (i.e., the upper surface, the left surface and the front surface) of the cubic prism set 12. Every two of the blue, red and green light valves 18, 20 and 22 are adjacent to each other. The three light valves 18, 20 and 22 are used for modulating the three primary color lights (R, G and B) transmitted or reflected by the prism set 12 to convert them into inversely polarized lights. The three primary color lights then pass through the prism set 12 and are then assembled into an output light beam sent to a projection lens (not shown). Finally, the output light beam is projected out.

The above light valves 18, 20 and 22 are reflective type liquid crystal panels including a red liquid crystal panel, a green liquid crystal panel and a blue liquid crystal panel or transmission type liquid crystal panels matched with reflecting mirrors. These transmission type liquid crystal panels also include a red liquid crystal panel, a green liquid crystal panel and a blue liquid crystal panel. The light valves 18, 20 and 22 can also be digital light processors (DLP). Moreover, the three primary color lights split from the incident lights can be either S-polarized or P-polarized.

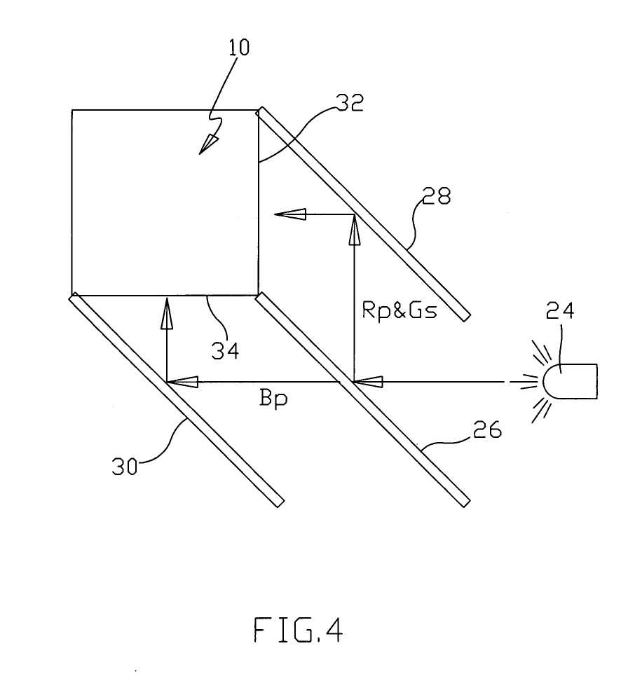

Before the incident light beams enter the reflective type beam splitting and combining device of the present invention, it is necessary to process them with a dichroic mirror and reflecting mirrors. As shown in FIG. 4, an incident light source 24 provides an incident light. A dichroic mirror 26 is located on the optical path of the incident light. This dichroic mirror 26 splits the incident light into two light beams of the three primary colors, which are reflected and transmitted, respectively. The reflected light beam includes a P-polarized red light (Rp) and an S-polarized green light (Gs). The transmitted light beam includes a P-polarized blue light (Bp). The P-polarized red light (Rp) and the S-polarized green light (Gs) are reflected by a reflecting mirror 28 to an incidence plane of the beam splitting and combining device 10. The P-polarized blue light (Bp) is reflected by a reflecting mirror 30 to another incidence plane of the beam splitting and combining device 10. A polarization conversion device or a polarization select component (not shown) is further provided outside the incident light source 24. The incident light passes through the polarization conversion device or the polarization select component to convert the three primary color lights into properly polarized ones before enters the beam splitting and combining device 10 (the dichroic mirror 26). Besides, it is also feasible to arrange a polarization select component in front of the above projection lens so that the output light beam can first pass through the polarization select component to select an appropriate polarization before entering the projection lens.

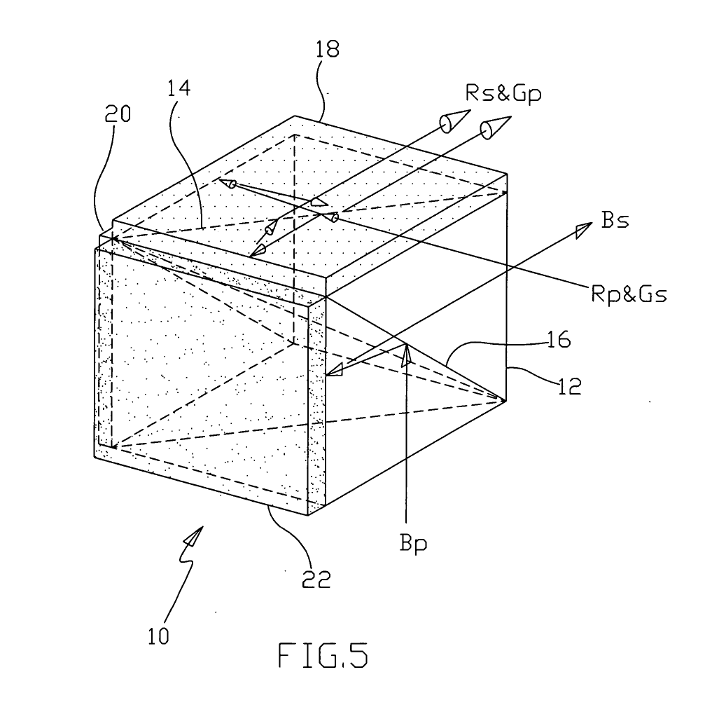

As shown in FIG. 5, the two light beams of the P-polarized red light (Rp) and the S-polarized green light (Gs) and the P-polarized blue light (Bp) enters the reflecting type beam splitting and combining device 10 of the present invention from the two incidence planes. The incident Rp and Gs are transmitted and reflected by the first dielectric thin film 14, respectively. Speaking more clearly, the Rp is transmitted through the first dielectric thin film 14, is converted into an S-polarized red light (Rs) by the red light valve 20, and is then reflected by the first dielectric thin film 14. The Gs is reflected by the first dielectric thin film 14, is converted into a P-polarized green light (Gp) by the green light valve 22, and is then transmitted through the first dielectric thin film 14. On the other hand, the Bp incident from the other incidence plane is first reflected by the second dielectric thin film 16, is converted into an S-polarized blue light (Bs), and is then transmitted through the second dielectric thin film 16. The Rs, Gp and Bs can thus be combined into an output light beam. The first dielectric thin film 14 and the second dielectric thin film 16 has the same optical characteristic as a polarizing beam splitter, and can split or combine S-polarized and P-polarized lights. Because the red light, green light and blue light are separately processed, they can more easily accomplish the splitting and combining function for the S-polarized and P-polarized lights than a full-spectrum (including the red, green and blue lights) PBS.

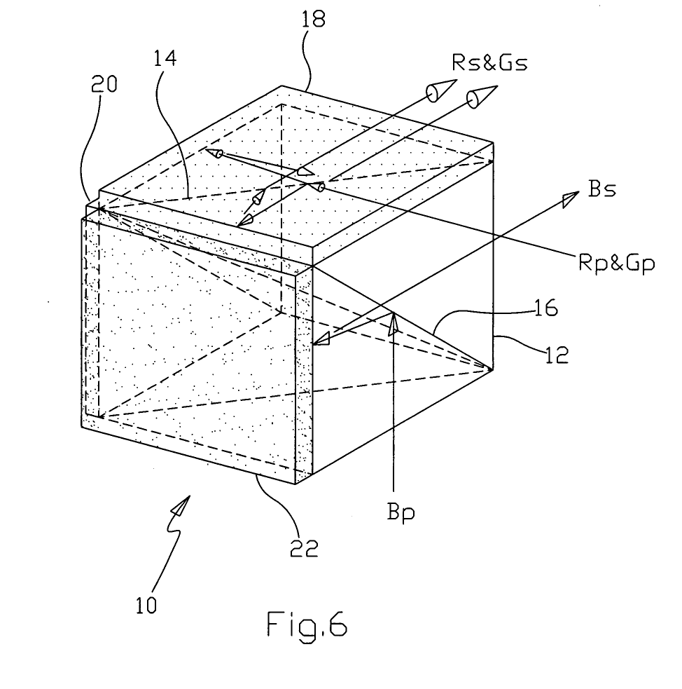

The three primary color lights (R, G and B) in the present invention can be either S-polarized or P-polarized according to different necessities. For instance, the incident three primary color lights can be simultaneously P-polarized or S-polarized. The dichroic mirror 26 is also changed accordingly to match the polarization and color-separation requirements. Then, it is only necessary to adjust the reflection/transmission characteristics of the two dielectric thin films. That is, the characteristics of the first and second dielectric thin films depend on the selected polarization. Their characteristics need to satisfy the optical paths and principles of the above three primary color lights. Besides, the incident primary color light beams incident from the two incidence planes may be embodied in other ways. It is only necessary to let the optical path of each primary color light match the corresponding light valve. Moreover, the arrangement ways have many choices. For instance, the incident three primary color lights (R, G and B) shown in FIG. 6 are all P-polarized (Rp, Gp and Bp). After processed for polarization splitting and combining by the first and second dielectric thin films having appropriate optical characteristics, lights reflected by the three light valves 18, 20 and 22 can be combined into an output light beam sent to a projection lens. There are also other polarization assembly ways of the three primary color lights (R, G and B). These different assemblies or arrangements are all embraced within the scope of the present invention.

The cubic optical structure of the prism set of the present invention has six surfaces. The three light valves are disposed on three surfaces adjacent to one another. Two of the remaining three surfaces are used as the incidence planes, and the last one is used as an exit plane of the output light beam. In other words, all the six surfaces of the above cubic optical structure are made use of to let the size of the beam splitting and combining device be very small and the number of required optical components be very little, hence greatly simplifying the assembly process of a reflective type optical image projection device or an optical engine and lowering the complexity and difficulty in assembly.

To sum up, the present invention makes use of a prism set having two special dielectric thin films matched with three different light valves to combine polarized light beams of the three primary colors into an output light beam for projection. The beam splitting and combining device of the present invention has the shortest back focus, and has also the advantages of a small size, simpler manufacturing, and a lower cost. Furthermore, the difficulty in manufacturing the optical engine can be effectively simplified.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A reflective type beam splitting and combining device comprising:
a prism set being a cubic structure, a first dielectric thin film being formed on a diagonal tangential plane of upper and lower opposed surfaces of said cubic, a second dielectric thin film being formed on a diagonal tangential plane of left and right opposed surfaces of said cubic, said prism set being used to respectively reflect and transmit two light beams of the three primary colors incident from two incidence faces; and
three light valves arranged on three adjacent surfaces of said prism set to let every two of them be adjacent to each other, said three light valves being used for modulating lights of the three primary colors transmitted or reflected by said prism set into inversely polarized ones, which are transmitted and reflected then and assembled into an output light beam by said prism set.

2. The reflective type beam splitting and combining device as claimed in claim 1, wherein said cubic prism set is formed by assembling four prisms and has six outer surfaces, the upper and lower opposed surfaces of said cubic has a diagonal tangential plane, and the left and right opposed surfaces of said cubic has another diagonal tangential plane.

3. The reflective type beam splitting and combining device as claimed in claim 2, wherein said prism set is formed by assembling said four prisms through gluing or a mechanical structure.

4. The reflective type beam splitting and combining device as claimed in claim 3, wherein the joint plane of said four prisms has a gap smaller than 15 micrometers.

5. The reflective type beam splitting and combining device as claimed in claim 1, wherein the material of said prism set is selected among glass and other materials transparent to the three primary colors.

6. The reflective type beam splitting and combining device as claimed in claim 1 further comprising a projecting lens for projecting out said output light beam.

7. The reflective type beam splitting and combining device as claimed in claim 1, wherein said light valves are reflective type liquid crystal panels including a red liquid crystal panel, a green liquid crystal panel and a blue liquid crystal panel.

8. The reflective type beam splitting and combining device as claimed in claim 1, wherein said light valves are transmission type liquid crystal panels matched with reflecting mirrors, said transmission type liquid crystal panels include a red liquid crystal panel, a green liquid crystal panel and a blue liquid crystal panel.

9. The reflective type beam splitting and combining device as claimed in claim 1, wherein said light valves are digital light processors.

10. The reflective type beam splitting and combining device as claimed in claim 1 further comprising before said two light beams of the three primary colors are incident into said incidence faces:
an incident light source for providing an incident light;
a beam splitting mirror located on the optical path of said incident light for splitting said incident light into two light beams of the three primary colors, one light beam is reflected, and the other light beam is transmitted through said beam splitting mirror; and
two reflecting mirrors for reflecting said two light beams of the three primary colors to said two incidence faces of said prism set.

11. The reflective type beam splitting and combining device as claimed in claim 10, wherein a polarization conversion device is further provided outside said incident light source, said incident light first passes said polarization conversion device to have a higher degree of the same polarization state before entering said beam splitting mirror.

12. The reflective type beam splitting and combining device as claimed in claim 10, wherein a polarization conversion device is further provided outside said incident light source, said incident light first passes said polarization conversion device to let said first and second dielectric thin films be able to split or combine S-polarized and P-polarized light beams before entering said beam splitting and combining device.

13. The reflective type beam splitting and combining device as claimed in claim 10, wherein a polarization select component is further provided outside said incident light source, said incident light first passes said polarization select component to let said first and second dielectric thin films be able to split or combine S-polarized and P-polarized light beams before entering said beam splitting and combining device.

14. The reflective type beam splitting and combining device as claimed in claim 6, wherein a polarization select component is further provided in front of said projection lens to let light first passing through said polarization select component before entering said projection lens.

15. The reflective type beam splitting and combining device as claimed in claim 1, wherein said first dielectric thin film and said second dielectric thin film are made with different coating conditions.

16. The reflective type beam splitting and combining device as claimed in claim 1, wherein said first dielectric thin film and said second dielectric thin film can split S-polarized and P-polarized light beams on the same optical path or combine S-polarized and P-polarized light beams on different optical paths.

17. The reflective type beam splitting and combining device as claimed in claim 2, wherein coated films on said diagonal tangential plane of the upper and lower opposed surfaces and said diagonal tangential plane of the left and right opposed surfaces of said cubic can split S-polarized and P-polarized light beams on the same optical path or combine S-polarized and P-polarized light beams on different optical paths.

18. The reflective type beam splitting and combining device as claimed in claim 1, wherein the three primary color lights incident from said two incidence planes could be S-polarized or P-polarized separately.

19. The reflective type beam splitting and combining device as claimed in claim 1, wherein the three primary color lights incident from said two incidence planes are simultaneously S-polarized or P-polarized.

20. The reflective type beam splitting and combining device as claimed in claim 1, wherein the three primary color lights incident from said two incidence planes have two S-polarized light beam and a P-polarized light beam or two P-polarized light beam and an S-polarized light beam.

21. The reflective type beam splitting and combining device as claimed in claim 1, which is used in optical image projection device including optical engines, projectors, back-projection televisions, digital movie projection devices, digital image simulators.
